(19) United States
(12) Patent Application Publication
(10) Pub. No.: US 2006/0129431 A1
(43) Pub. Date: Jun. 15, 2006

(54) Physicians-patients-health-care-buyers accounting system

(76) Inventors: Anuthep Benja-Athon, New York, NY (US); Nontawan Benja-Athon, Port Washington, NY (US)

Correspondence Address: ANUTHEP BENJA-ATHON, M.D.;Nontawan Benja-athon, 210 E 36th st., New York, NY, 10016, US

(21) Appl. No.: 11/344,485

(22) Filed: Feb. 1, 2006

Related U.S. Application Data
(63) Continuation-in-part of application No. 11/293,689, filed on Dec. 5, 2005.
(63) Continuation-in-part of application No. 11/114,763, filed on Apr. 27, 2005.
(63) Continuation-in-part of application No. 10/328,993, filed on Dec. 26, 2002.

(51) Int. Cl. G06Q 10/00

(52) U.S. Cl. 705/2; 707/7

(57) ABSTRACT

A computer-automated system of using first data in digital text data derived from digital voice data comprising health and health-care information to extract second data in databases comprising health and health-care information and corresponding individual monetary values for accounting compensations for individual physicians and accounting health-care expenses of individual patients and health-care buyers.

This application is a continuation-in-part of Ser. No. 11/293,689 entitled System of conserving health-care buyers' resources and a continuation-in-part of Ser. No. 11/114,763 entitled A System of Influencing Health-Care Utilizations filed Apr. 27, 2005 which are pending.

### FIELD OF INVENTION

An electronic accounting system for physicians, patients and health-care buyers.

### BACKGROUND OF THE INVENTION

The systems, methods and processes taught in the pending patent applications of the current applicants and other co-applicants lead to the innovation of the present invention wherein computer commands and health and health-care data and information present to and in a network of computers and servers are used to computer-automatically process and generate information pertaining to the accountings and tallying of compensations for physicians and expenses of patients and health-care buyers.

The consequences of the present invention are the tremendous saving billions of dollars each year and improvement of standard of living and quality of life for said parties and the saving of lives in U.S.A. and the world.

### SUMMARY OF THE INVENTION

The present invention is a computer-automated system of using computer program or programs to apply first data in digital text data derived from digital voice data comprising health and health-care information on patients generated by individual physicians to relate and extract second data in databases comprising health and health-care information and corresponding individual monetary values assigned to individual components of said health and health-care information generated and store in computers and/or servers for producing outcomes for accounting compensations for individual physicians for said physicians' services rendered to patients and accounting health-care expenses of individual patients and health-care buyers wherein said accountings are viewable on the display screens of computers in a network of computers and servers.

### DESCRIPTION OF PREFERRED EMBODIMENTS

The present invention is a system of accounting or tallying compensations for individual physicians for said physicians' services rendered to patients and accounting or tallying health-care expenses of individual patients and individual health-care buyers wherein digital text data derived from digital voice data comprising health and health-care information on patients generated by individual physicians and databases comprising health and health-care data and corresponding individual monetary values assigned to individual components of said health and health-care data are used to produce said system of accounting compensations and expenses viewable on the display screens of computers in a network of computers and servers.

The preferred embodiments of the present invention is a computer-automated system comprises computer program or programs of commands and codes to apply first data in health and health-care information on patients generated by physicians and inputted said information into electronic devices including computers network to a network of computers or servers—taught in the earlier and pending patent applications of this physician applicant and his co-applicants—to computer-automatically relate and extract second data in databases comprising health and health-care information and corresponding individual monetary values assigned to individual components of said health and health-care information generated and store in computers and/or servers for computer-automatically producing outcomes for accounting compensations for individual physicians for said physicians' services rendered to patients and computer-automatically producing outcomes for accounting health-care expenses of individual patients and health-care buyers wherein said accountings are viewable on the display screens of computers in a network of computers and servers

Said system uses data in said digital text data comprising health and health-care information on patients generated by said physicians according to earlier teachings in the pending patents of this physician patent applicant and his other co-applicants. Said data are based on the following mathematical expression or relationship:

<Category><Payable>

<Categories 1-n><Payables 1-n>

Similarly, said databases comprising said health and health-care information and corresponding individual monetary values assigned to individual components of said health and health-care information generated and store in computers and/or servers are based on the following mathematical expression or relationship:

<Category><Payable><Cost>

<Categories 1-n><Payables 1-n><Costs 1-n>

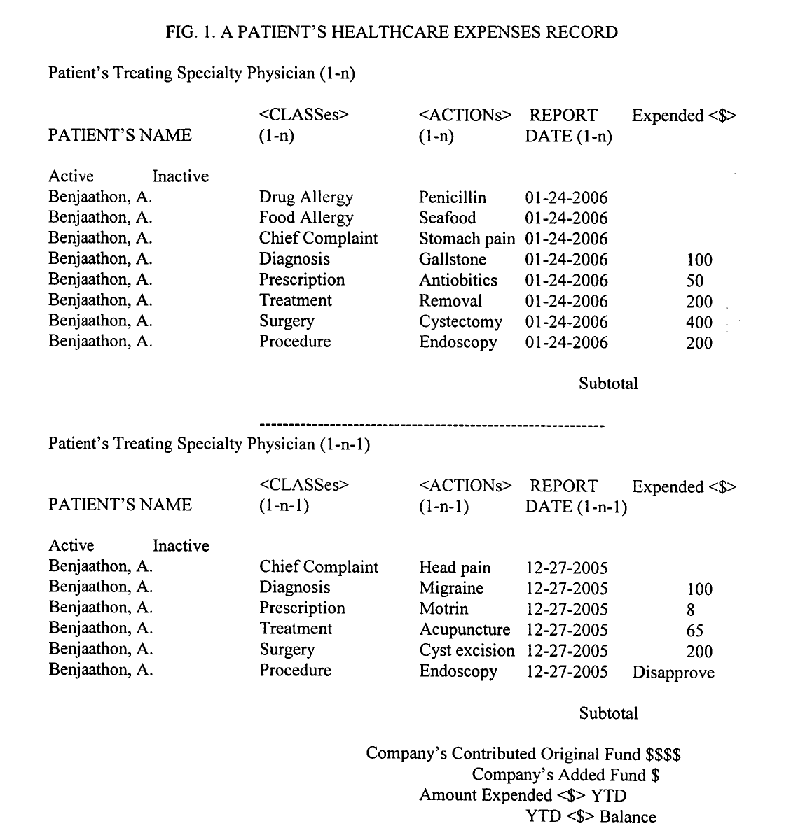

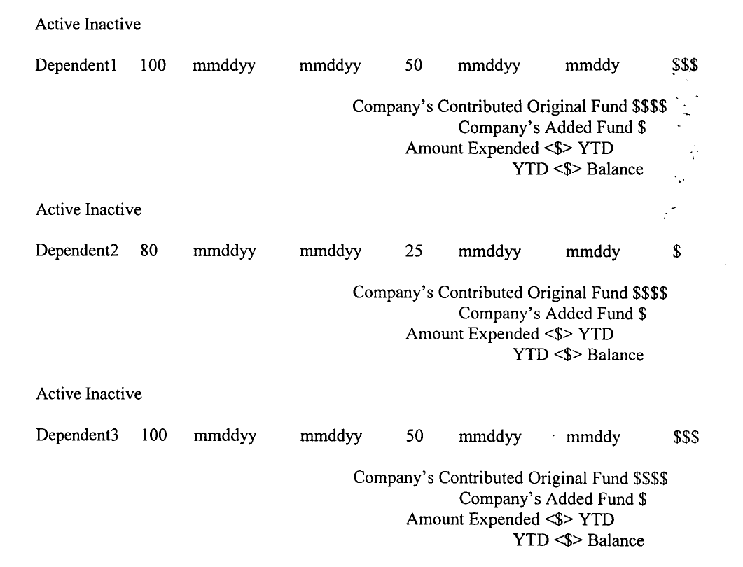

In said expressions, n=range of 1 to a very large number. Said payable and payables are subject and subjects infra and said cost and costs are individual monetary values infra in the claims of the present invention. Said costs extracted from databases represented by contents in FIG. 5 are used by the computer or computers and program or programs described infra to produce the information present in FIGS. 1-4.

The explanation of said expression or relationship is that categories or headings, topics or types in medicine, surgeries and health-care as described in the preferred embodiments of this physician applicant's and co-applicant's applications and being applied herein comprises, for example, Drug Allergy, Food Allergy, Chief Complaint, Diagnosis, Differential Diagnosis, Treatment, Procedure, Prescription, Surgery, Office Visit, Consultation, Test, Recommendation, Referred Physicians, Hospital, Clinics and Messages, etc. and their pleurals.

The explanation of said expression or relationship is that said payables in medicine, surgeries and health-care are information such as, but not limited to, medical, surgical and health-care words, terms and phrases present in or associate with said categories and being used by physicians in medicine, surgeries and health-care. Said information are found in medicine, surgeries and health-care dictionaries comprising hundreds of thousands to millions of words, terms and phrases. For example, a very small representation of said information or an extremely small excerpt from said dictionaries is angiography, asthma, Bell's palsy, biopsy, carotid endarterectomy, caesarian section, coma, coronary artery bypass graft, dyslexia, edema, emphysema, excision, endoscopy, fever, gout, grafting, hemorrhage, hernia repair, infection, injection, jaundice, kidney infection, lymphoma, leukemia, meningitis, mammography, narcolepsy, narcotic analgesics, otitis media, paralysis, Q fever, rhinitis, sickle cell disease, stent placement, typhoid fever, uremia, viral meningitis, whipple disease, xerostoma, x-ray, yellow fever, etc.

In other words, one representation of millions of pages of said data in said health and health-care information on patients generated by physicians on daily basis on patients and inputted into electronic devices including computers network to a network of computers or servers—taught in the earlier and pending patent applications of this physician applicant and his co-applicants—viewable on display screen or screens using only one patient as an example—among many patients—for illustration is as follows:

| Patients' Names | <Categories> | <Payables> | Report Date |
|---|---|---|---|
| Benjaathon, A. | Drug Allergy | Penicillin | 01-24-2006 |
| Benjaathon, A. | Food Allergy | Seafood | 01-24-2006 |
| Benjaathon, A. | Chief Complaint | Stomach pain | 01-24-2006 |
| Benjaathon, A. | Diagnosis | Gallstone | 01-24-2006 |
| Benjaathon, A. | Prescription | Antiobitics | 01-24-2006 |
| Benjaathon, A. | Treatment | Removal | 01-24-2006 |
| Benjaathon, A. | Surgery | Cystectomy | 01-24-2006 |
| Benjaathon, A. | Procedure | Endoscopy | 01-24-2006 |

Furthermore, said costs in said expression or relationship are the costs of goods such as, but not limited to, drugs, medications, disposable and durable goods, and the corresponding costs of medical and surgical health-care services relating to payables. For example, said costs of office visit to a physician is $120, angiography is $300, diagnosis of asthma is $120, treatment of Bell's palsy is $300, biopsy of breast cyst is $400, carotid endarterectomy is $1,000, caesarian section is $600, coronary artery bypass graft is $3000, endoscopy is $300, hernia repair is $300, stent placement is $300, etc. The number of costs=the number of said payables.

In other words, one representation of thousands of pages of said data in said databases comprising health and health-care information and corresponding individual monetary values assigned to individual components of said health and health-care information and to continue with said table is as follows:

| <Categories> | <Payables> | <Costs> in $ |
|---|---|---|
| Drug Allergy | Penicillin | |
| Food Allergy | Seafood | |
| Chief Complaint | Stomach pain | |
| Diagnosis | Gallstone | 100 |
| Prescription | Antiobitics | 50 |
| Treatment | Removal | 200 |
| Surgery | Cystectomy | 400 |
| Procedure | Endoscopy | 200 |

It is also explained herein that said costs are adjustable or variable and will be different for different regions of the U.S.A. and the other part of the world due to different costs of living, labor, business, goods and services.

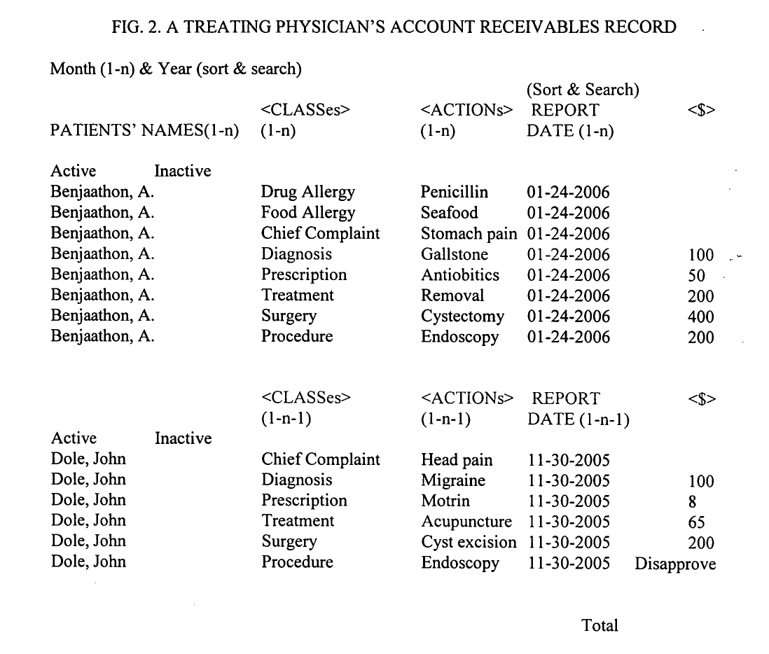

The present invention provides a computer command means for relating each and every <Category><Payable> in said data presented to said computers and/or servers to same said each and every <Category><Payable> in databases store in said computers and/or servers to extract <Costs> from said databases to achieve the objectives of the present invention. Furthermore, The present invention provides a computer command means for extracting each and every <Cost> in said databases based on said <Category><Payable> in said data and databases to achieve the objectives of the present invention. One representation of the results of said process is shown in FIGS. 1 and 2.

Thus, said health and health-care information generated by physicians represent by said <Category><Payable> and said <Categories 1−n><Payables 1−n> and said databases comprising health and health-care information and corresponding individual monetary values assigned to individual components of said health and health-care data represent by said <Category><Payable><Cost> and said <Categories 1−n><Payables 1−n><Costs 1−n> which are automatically used by said computers whose programs and software computer-automatically relate said relationships and extract said data leading to computer-automatically producing displays of accountings or tallyings on display screens of computers. Consequently, said accountings or tallies for said physicians, patients or health-care consumers, and health-care buyers such as, but not limited to, companies, corporations, employers and self-insured or uninsured patients and the like are viewed by said entities so that they can efficiently monitor or even modulate financial matters in health-care such as, but not limited to, their revenues, earnings, expenses and/or costs, etc. FIGS. 1 and 2 represent the preferred embodiments of the present invention wherein the products or outcomes of said computerized automation permeate throughout said network of computers and servers to appear as contents and the like in FIGS. 1 and 2 on the display screens of computers and being viewed by the designated and appropriate said viewers—patients, physicians, employers, and staff of companies and corporations. Therefore, the productions of said displays and the like in FIGS. 1 and 2 are computer-automated by said computers and programs and software.

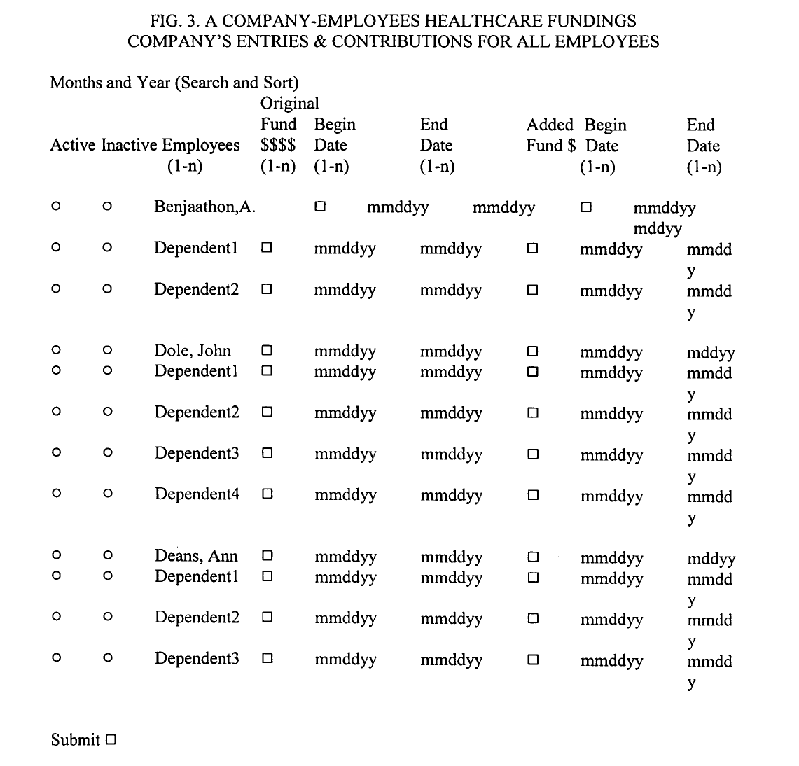

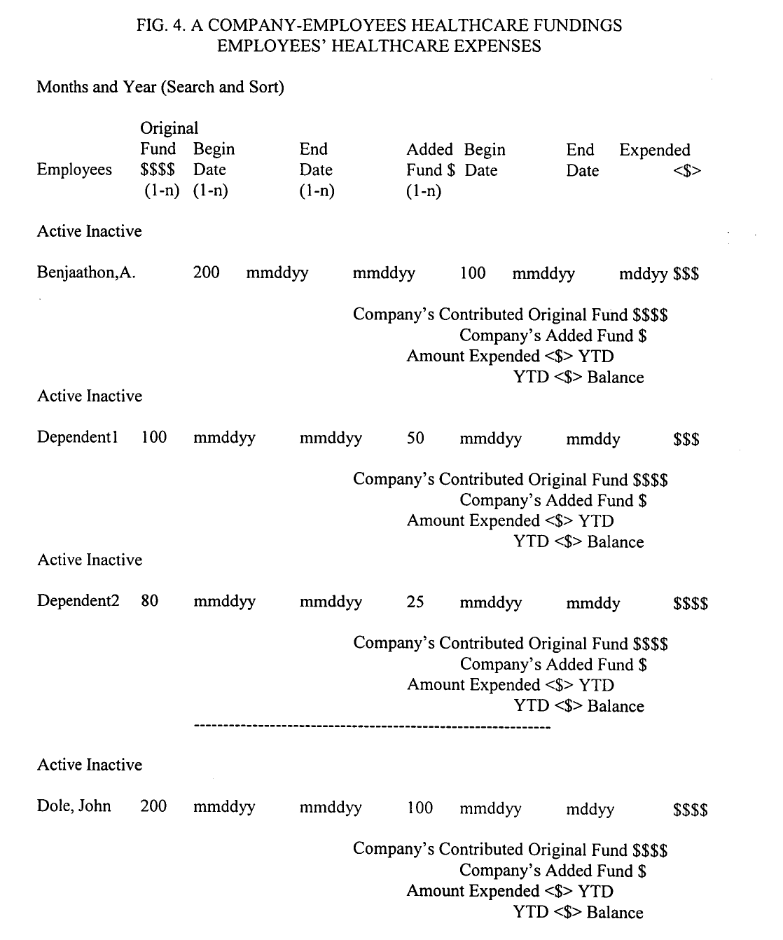

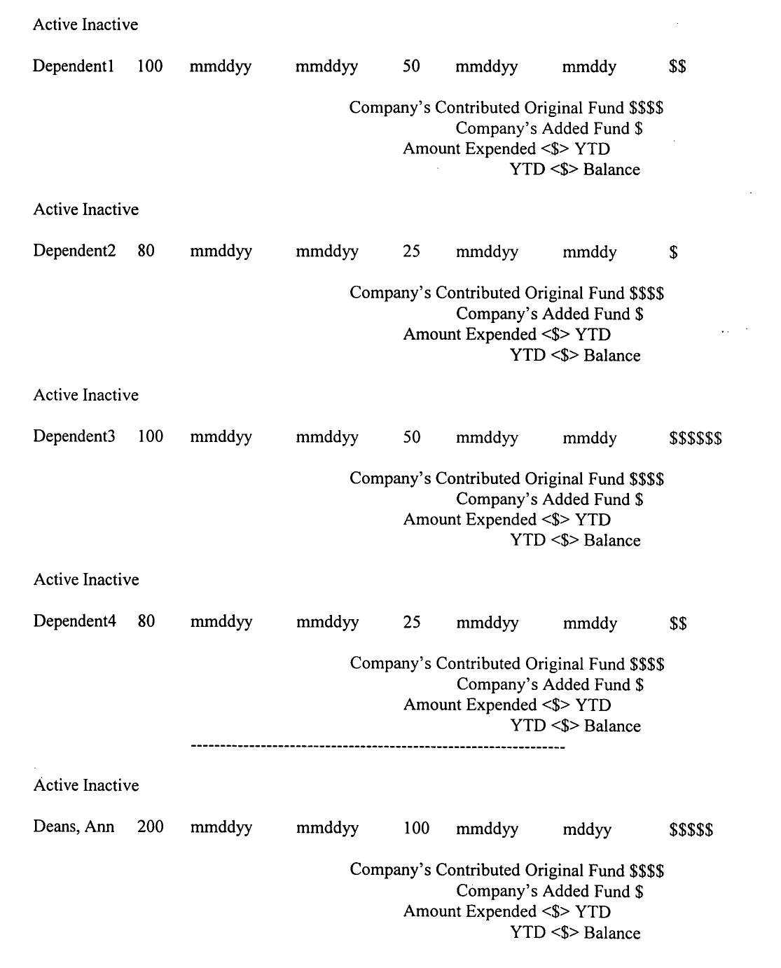

However, some human inputs or entries are needed to generate or update the funding aspect of the preferred embodiments of the present invention. For example, FIG. 3 shows circles, squares and mmddyy into which appropriate information such as, but not limited to, indication if any employee is actively or inactively employed by a company, funds are added and the dates of said activities or occurrences. FIG. 4 shows the outcomes of said inputs or entries in said FIG. 3.

FIG. 1 represents said process leading to tallying of amounts of expenses of a patient relating to said patient's health-care expenses relating to physicians and other health-care providers. Said figure or display or similar figures or displays is or are produced as a process of tallying amounts of expenses of individual patients.

FIG. 2 represents said process leading to tallying of amounts of compensations for a physician for said physician's services to patients. Said figure or display or similar figures or displays is or are produced as a process of tallying amounts of compensations for individual physicians for said physicians' services to patients.

FIG. 4 represents the outcome of a process of tallying amounts of expenses of a health-care buyer relating to said buyer's employees, retirees and their dependents and the entries or inputs in FIG. 3. Said figure or display or similar figures or displays is or are produced as a process of tallying amounts of expenses of individual health-care buyers.

Moreover, the common words or phrases present in or share by FIGS. 1-4 represent said products or outcomes of said computerized automation permeating throughout said network of computers and servers to appear as contents and the like in FIGS. 1-4 on the display screens of computers and being viewed by the designated and appropriate or authorized said viewers—patients, physicians, employers, and staff of companies and corporations. Therefore, the productions of said displays and the like in FIGS. 1-4 are computer-automated by said computers and programs and software.

It is understood that the above preferred embodiments apply to tens or hundreds of millions of patients and health-care buyers and physicians who participate in the care of or the delivery of care to said patients and those physicians and assistants who participate in this system or use the methods and processes of the present invention and said pending patent applications.

It is understood that health-care consumers are patients although employers, companies, corporations and governments may also be defined as health-care consumers, and health-care buyers are such as, but not limited, to employers, companies, corporations, governments and certain patients. The commonly well-known certain patients are the tens of millions of uninsured Americans.

The terms health-care, health care and healthcare have the same meaning and application herein. Health-care resources used herein are such as, but not limited to, dollars or money that are owned or controlled by health-care buyers and consumers.

Although the preferred embodiments have been described using specific expressions of relationships of data and items described herein <Category><Payable><Cost>, <Categories><Payables><Costs>, <Category><Payable>, <Categories 1−n><Payables 1−n> and <Categories 1−n><Payables 1−n><Costs 1−n> and the illustrations in FIGS. 1-4, it will be appreciated by those skilled in the art that variations, additions and adaptations to said preferred embodiments can be made without departing from the spirit of the invention and the scope of the claims.

Although the preferred embodiments of the present invention are a computer-automated system of using digital text data derived from digital voice data comprising health and health-care information on patients generated by individual physicians and databases comprising health and health-care data and corresponding individual monetary values assigned to individual components of said health and health-care data for accounting compensations for individual physicians for said physicians' services rendered to patients and accounting health-care expenses of individual patients and health-care buyers wherein said accountings are viewable on the display screens of computers in a network of computers and servers, it will be appreciated by those skilled in the art that some additional human interventions or inputs may be applied to the present invention without departing from the spirit of the invention and the scope of the claims.

Although the preferred embodiments have been described, it will be appreciated by those skilled in the art that variations, additions and adaptations to the present invention can be made without departing from the spirit of the invention and the scope of the claims.

1. A system of accounting compensations for individual physicians for said physicians' services rendered to patients and accounting health-care expenses of individual patients and health-care buyers wherein digital text data derived from digital voice data comprising health and health-care information on patients generated by individual physicians and databases comprising health and health-care information and corresponding individual monetary values assigned to individual components of said health and health-care information are used to produce said system of accounting compensations and expenses viewable on the display screens of computers in a network of computers and servers comprises:
digital text data comprising health and health-care information on patients generated by individual physicians;
databases comprising health and health-care data and corresponding individual monetary values assigned to individual components of said health and health-care data;
a computer command means for relating first data in said digital text data and same data in said databases;
a computer command means for extracting second data in in said databases;
a process of relating data in said digital text data and same data in said databases;
a process of expressing the outcomes of said process of relating data in said digital text data and same data in said databases; and
a process of displaying the outcomes of said process of relating data in said digital text data and said data in said databases on computer display screens.

2. The system according to claim 1 wherein said digital text data comprising health and health-care information on patients generated by individual physicians comprise individual categories and relating individual subjects.

3. The system according to claim 1 wherein said databases comprising health and health-care data and corresponding individual monetary values assigned to individual components of said health and health-care data comprise said individual subjects and corresponding individual monetary values.

4. The system according to claim 1 wherein said process of relating data in said digital text data and said data in said databases comprises a process of relating individual categories and relating individual subjects in said digital text data to same individual categories and same individual subjects in said databases.

5. The process of relating according to claim 4 comprises a process of extracting data from said databases.

6. The system according to claim 1 wherein said process of expressing the outcomes of said process of relating data in said digital text data and same data in said databases comprises a process of tallying compensations for individual physicians for said physicians' services rendered to patients.

7. The system according to claim 1 wherein said process of expressing the outcomes of said process of relating data in said digital text data and same data in said databases comprises a process of tallying health-care expenses of individual patients.

8. The system according to claim 1 wherein said process of expressing the outcomes of said process of relating data in said digital text data and same data in said databases comprises a process of tallying health-care expenses of individual health-care buyers.

9. The system according to claim 1 wherein said process of displaying the outcomes of said process of relating data in said digital text data and said data in said databases on computer display screens comprises a process of displaying compensations for individual physicians for said physicians' services rendered to patients.

10. The system according to claim 1 wherein said process of displaying the outcomes of said process of relating data in said digital text data and said data in said databases on computer display screens comprises a process of displaying health-care expenses of individual patients.

11. The system according to claim 1 wherein said process of displaying the outcomes of said process of relating data in said digital text data and said data in said databases on computer display screens comprises a process of displaying health-care expenses of individual health-care buyers.

12. A system of computer-automated tallies of amounts of compensations for physicians' services rendered to patients and amounts of health-care expenses of health-care buyers and health-care consumers wherein digital text data derived from digital voice data comprising health and health-care information on patients generated by said physicians and databases comprising health and health-care information and corresponding individual monetary values assigned to individual components of said health and health-care information and wherein said tallies are viewable on the display screens of computers in a network of computers and servers comprises:
digital text data comprising health and health-care information on patients generated by individual physicians;
databases comprising health and health-care data and corresponding individual monetary values assigned to individual components of said health and health-care data;
a computer command means for relating first data in said digital text data and same data in said databases;
a computer command means for extracting second data in in said databases;
a process of relating data in said digital text data and same data in said databases;
a process of expressing the outcomes of said process of relating data in said digital text data and same data in said databases; and
a process of displaying the outcomes of said process of relating data in said digital text data and said data in said databases on computer display screens.

13. A computer-automated system of using first data in digital text data derived from digital voice data comprising health and health-care information on patients generated by individual physicians to extract second data in databases comprising health and health-care information and corresponding individual monetary values assigned to individual components of said health and health-care information for accounting compensations for individual physicians for said physicians' services rendered to patients and accounting health-care expenses of individual patients and health-care buyers wherein said accountings are viewable on the display screens of computers in a network of computers and servers comprises:
digital text data comprising health and health-care information on patients generated by individual physicians;
databases comprising health and health-care data and corresponding individual monetary values assigned to individual components of said health and health-care data;
a computer command means for relating first data in said digital text data and same data in said databases;
a computer command means for extracting second data in in said databases;
a process of relating data in said digital text data and same data in said databases;
a process of expressing the outcomes of said process of relating data in said digital text data and same data in said databases; and
a process of displaying the outcomes of said process of relating data in said digital text data and said data in said databases on computer display screens.
